(19) United States
(12) Patent Application Publication
(10) Pub. No.: US 2026/0348878 A1
(43) Pub. Date: Nov. 5, 2026

(54) CONTROL METHOD AND SYSTEM TO CONTROL THE INTEGRITY OF ARTICLES MADE OF A COMPACTED CERAMIC MATERIAL

(71) Applicant: SACMI COOPERATIVA MECCANICI IMOLA SOCIETÁ COOPERATIVA, Imola, BO (IT)

(72) Inventors: Paolo Testi, Imola, BO (IT); Marco Capponi, Imola, BO (IT)

(21) Appl. No.: 19/487,968

(22) PCT Filed: May 29, 2024
(86) PCT No.: PCT/IB2024/055194

§ 371 Date: Nov. 25, 2025

(30) Foreign Application Priority Data
May 30, 2023 (IT) 102023000010929

(51) Int. Cl. G01N 21/956; G01N 21/84; G01N 21/88; G01N 21/89

(52) U.S. Cl. CPC G01N 21/95607; G01N 21/8806; G01N 21/8914; G01N 2021/845; G01N 2021/8838; G01N 2021/95615

(57) ABSTRACT

A control method and system to control the integrity of articles made of a compacted ceramic material; said control system comprises: a feeding surface; a lighting unit to emit at least one light beam towards said feeding surface; a detection system to capture at least two images of at least two edge portions of two respective side edges of said substantially flat article illuminated by said lighting unit; and a processing unit to process the captured images so as to identify possible defects.

### CROSS-REFERENCE TO RELATED APPLICATIONS

This Patent Application claims priority from Italian Patent Application No. 102023000010929 filed on May 30, 2023, the entire disclosure of which is incorporated herein by reference.

### TECHNICAL FIELD

The present invention relates to a control system and method to control the integrity of articles made of a compacted ceramic material.

In particular, the invention refers to a control system and method to control the integrity of substantially flat articles comprising (in particular made of) compacted ceramic powder not yet subjected to heat treatments, such as for example drying and firing. More in particular, the present invention is advantageously but not exclusively applied to the field of the production of slabs or tiles made of a ceramic material.

### BACKGROUND OF THE INVENTION

In the field of the production of ceramic products, in particular of slabs or tiles made of a ceramic material, it is known to supply semi-dry ceramic powder (i.e. with a humidity content of less than 10%, in particular ranging from 5% to 6%) along a given path through a discontinuous compaction machine (commonly known as press), or a continuous compaction assembly, which subjects the ceramic powder to a compaction pressure so as to obtain a layer of compacted ceramic powder, which (at least when the compaction occurs by means of a continuous compaction machine) is cut so as to obtain a plurality of substantially flat articles made of a compacted ceramic material, which are then dried, possibly subjected to decorating and/or finishing operations, and finally fired so as to obtain the final ceramic products.

In some cases, during the forming operations of the articles, surface defects can arise, such as for example surface swellings and/or cracks, especially in the edge zones due, for example, to a different humidity of the ceramic powder, to granulometric defects or to air bubbles embedded in the ceramic material during the compaction. Such defects, besides compromising the quality of the final ceramic products making them unusable, can lead to the breakage, or in some cases the explosion, of the articles during the drying or the firing.

The importance of a thorough control of the integrity of the articles before proceeding with the drying and firing operations is thus understood. In fact, the presence of such surface and/or edge defects, besides determining the rejection of articles with consequent economic losses which are all the greater the larger the dimension of the articles, risks, in case of breakage or explosion of the article, damaging or at least dirtying the heat treatment machines, with the consequent need for maintenance operations and restoration of the normal operating conditions, which, sometimes, can involve long periods of machine downtime.

To date, such control of the integrity of the articles is performed manually by operators who inspect the articles just downstream of the compaction station and, in order to identify possible surface and/or edge defects, which are normally so small that they are difficult to be seen with the naked eye, utilize contrast media, for example contrast liquids such as acetone or diesel oil, which are applied to the articles, or anyway at least to some edge zones of such articles, and left to act so as to make such defects more visible.

Such control methods anyway have some drawbacks. First of all, the control operations imply the presence of operators in charge of manually performing the inspection of the articles, with all the problems of precision, reliability and repeatability typical of manual operations.

Furthermore, such control operations require a certain time, especially for applying the above-mentioned contrast media and leaving them act, resulting in increased time and thus decreased productivity.

The object of the present invention is to provide a control method and system for controlling the integrity of substantially flat articles made of a compacted ceramic material, which allow overcoming at least in part the drawbacks of the prior art.

### SUMMARY

In accordance with the present invention, a control method and system are proposed for controlling the integrity of articles made of a compacted ceramic material, according to what claimed in the appended independent claims, and preferably, in any one of the claims directly or indirectly dependent on the mentioned independent claims.

The claims describe preferred embodiments of the present invention, forming integral part of the present description.

### BRIEF DESCRIPTION OF THE DRAWINGS

The invention is described in the following with reference to the accompanying drawings, which illustrate some non-limiting example embodiments thereof, wherein:

FIG. 1 represents a schematic view of a manufacturing plant for manufacturing ceramic products, such as ceramic slabs and tiles, according to a first aspect of the present invention;

FIG. 2 represents a perspective view of a control system for detecting the integrity of an article, in this case of a tile made of a compacted ceramic material, in accordance with an embodiment of the present invention;

FIG. 3 represents, on an enlarged scale, the control system illustrated in FIG. 2, in which some parts have been removed so as to better view other ones, during a step of a control process of the integrity of the tile made of a compacted ceramic material;

FIG. 4 represents on an enlarged scale the control system illustrated in FIG. 3 but from another angle and during a subsequent step of the control process of the integrity of the tile made of a compacted ceramic material; and

FIGS. 5 and 6 represent two side views of the control system of FIG. 2, in which some parts have been removed so as to better view other ones.

### DETAILED DESCRIPTION

In the accompanying figures, reference numeral 1 indicates, as a whole, a manufacturing plant for manufacturing ceramic products 2, such as for example ceramic slabs or tiles.

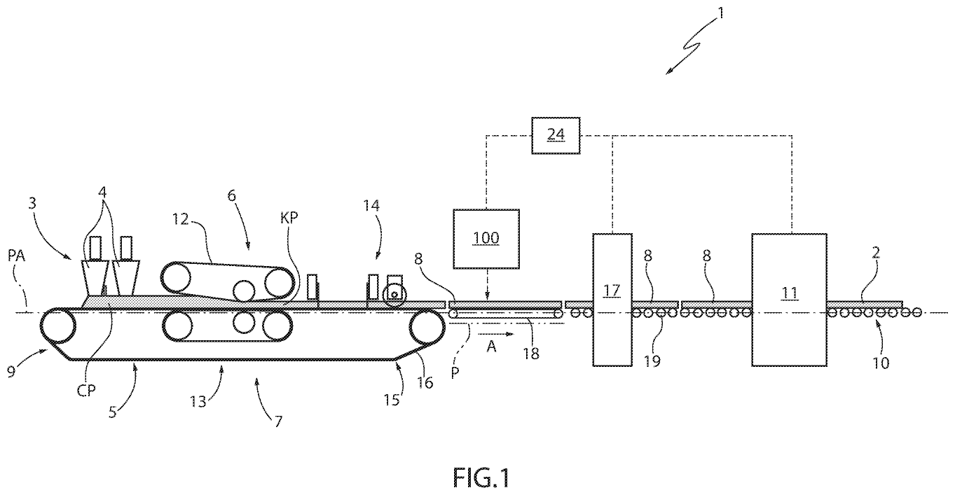

With particular reference to FIG. 1, advantageously, the manufacturing plant 1 for manufacturing ceramic products 2 comprises: a supply assembly 3 advantageously provided with at least one supply device 4 (known per se and not specifically described herein) configured to supply ceramic powder CP, in particular, a controlled quantity of ceramic powder CP, at an input station 5 in a manner known per se; a forming assembly 6, arranged at a forming station 7, and configured to form at least one substantially flat article 8 comprising (in particular, made of) a compacted ceramic material; and a conveyor assembly 9 which extends along a given path PA in a feeding direction A from the input station 5 to an output station 10, advantageously but not limitedly comprising a plurality of conveyors 16, 18, 19 arranged in sequence (as it will be better explained in the following), and is configured to transport the ceramic powder CP from the input station 5 to the forming station 7 and the substantially flat article 2 from the forming station 7 to a kiln 11.

In the present discussion, the expression “substantially flat article 8 made of a compacted ceramic material” or more simply “article 8” refers to a substantially (but not necessarily) plane article made of a ceramic material, namely consisting of the above-mentioned compacted ceramic powder CP; more in particular, it refers to a base article intended for forming a ceramic slab or tile, namely an intermediate article not yet subjected to the heat treatments, for example drying and firing, which will then lead to the manufacturing of the actual ceramic product 2.

Still more advantageously but not limitedly, the article 8 comprises (in particular, is) a slab made of a compacted ceramic material having two larger surfaces S parallel to and opposite each other and at least four side surfaces L perpendicular to the larger surfaces S and two by two parallel to and opposite each other.

Advantageously but not limitedly, the forming assembly 6 comprises at least one continuous or discontinuous compaction device 12 configured to apply a compaction pressure to the ceramic powder CP.

More in particular, according to some advantageous but non-limiting embodiments, such as for example the one illustrated in FIG. 1, the forming assembly 6 comprises a compaction device 12 of continuous type (known per se and not specifically described herein), arranged at a compaction station 13 which is (part of the forming station 7 and is) placed downstream of the supply assembly 3 along the given path PA and is configured to apply a compaction pressure to the ceramic powder CP so as to obtain a strip of compacted ceramic powder KP and a cutting device 14 which is located at a cutting station 15, which is (part of the forming station 7 and is) arranged downstream of the compaction station 13 along the given path PA, and is configured to cut the layer of compacted ceramic powder KP so as to obtain a plurality of substantially flat articles 8 made of a compacted ceramic material, which are supplied at the output of such forming station 7 by means of the conveyor assembly 9, for example (as in the case illustrated in FIG. 1) by means of a belt conveyor 16.

According to other advantageous but non-limiting embodiments not illustrated, the forming assembly 6 comprises (in particular, consists of) a discontinuous compaction device (commonly known as discontinuous press, known per se and not specifically described herein), configured to impress a defined compaction pressure to a layer of ceramic powder CP and obtain at least one substantially flat article 8 made of a compacted ceramic material.

Advantageously, the manufacturing plant 1 also comprises the above-mentioned kiln 11, arranged downstream of the forming station 7 along the given path PA and configured to fire the substantially flat article 8 made of a compacted ceramic material at a firing temperature of at least approximately 1000 °C (in particular, at a firing temperature ranging from approximately 1000 °C to approximately 1400 °C) so as to obtain a ceramic product 2.

In accordance with some advantageous but non-limiting embodiments, such as the one illustrated in FIG. 1, the manufacturing plant 1 also comprises at least one drier 17 arranged downstream of the forming station 7 and upstream of the kiln 11 along the given path PA for drying the substantially flat article 8 made of a ceramic material.

Advantageously, the manufacturing plant 1 for manufacturing ceramic products 2 also comprises a control system 100 for controlling the integrity of the substantially flat articles 8 made of a compacted ceramic material which is arranged downstream of the forming station 7 along the given path PA.

In particular, according to an aspect of the present invention, a control system 100 is in fact presented, particularly suitable for controlling (in particular, inspecting) the substantially flat articles 8 made of a compacted ceramic material formed by means of the above-mentioned forming assembly 6 in order to identify possible surface defects, for example due to the embedding of air in the compacting step, and/or edge defects, such as for example cracks or damage.

With particular reference to FIG. 1, advantageously the control system 100 is arranged upstream of the kiln 11 along the given path PA.

Alternatively or in combination, when a drier 17 is also provided (as in the embodiment illustrated in FIG. 1), more advantageously but not limitedly, the control system 100 is arranged upstream of the drier 17 along the given path PA.

In particular, according to some advantageous but non-limiting embodiments, the control system 100 is arranged downstream of the forming station 7.

Still more advantageously but not limitedly, the control system 100 is arranged immediately (without interpositions of other stations) downstream of the forming station 7.

Alternatively or additionally, according to other advantageous but non-limiting embodiments, the control system 100 is arranged at the forming station 7, in particular immediately downstream of the compaction device 12 (more in particular, immediately downstream of the compaction station 13 along the given path PA). Still more advantageously but not limitedly, the control system 100 is arranged between the compaction device 12 and the cutting device 14 (in particular, between the compaction station 13 and the cutting station 15 along the given path PA).

Advantageously but not limitedly, the conveyor assembly 9 comprises the above-mentioned belt conveyor 16 on which the supplied ceramic powder CP is laid and which is configured to supply ceramic powder CP through the forming assembly 6 and a further conveying device 18, for example in the illustrated case a belt conveyor or alternatively a roller conveyor, which is arranged downstream of the belt conveyor 16 along the given path PA and is part of the control system 100 and further conveyors 19, for example in the illustrated case roller conveyors, for supplying the substantially flat articles 8 already controlled through the subsequent stations, in the illustrated case through the drier 17 and the kiln 11.

It is understood that the manufacturing plant 1 could comprise any number of intermediate stations between the control system 100 and the kiln 11, for example decoration and/or surface treatment stations of the article 8.

Advantageously, the control system 100 comprises a feeding surface 20, for receiving at least one substantially flat article 8 comprising (in particular, made of) a compacted ceramic material and convey it along a feeding path P, which advantageously but not limitedly is part of (in particular, coincides with a section of) the above-mentioned given path PA, in the above-mentioned feeding direction A.

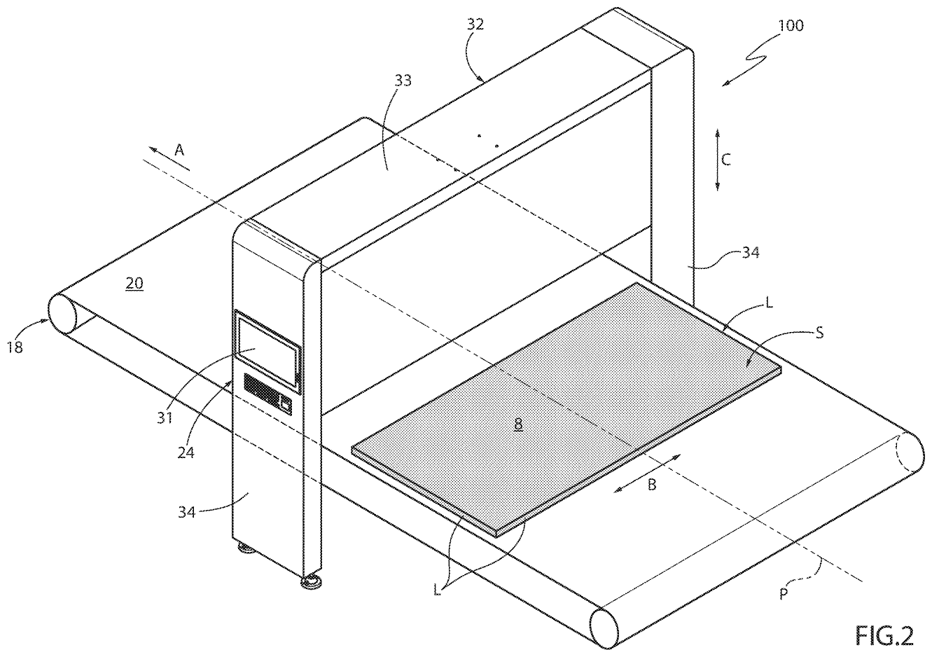

Still more advantageously but not limitedly, as mentioned above, according to some advantageous but non-limiting embodiments, as for example the one illustrated in the accompanying figures, the control system 100 comprises the above-mentioned conveying device 18 and the feeding surface 20 is defined by an upper branch of such conveying device 18 (see for example FIG. 2). It is understood that according to other non-limiting embodiments not illustrated, the control system 100 could comprise other types of feeding devices, for example a roller conveyor or any other movable plane.

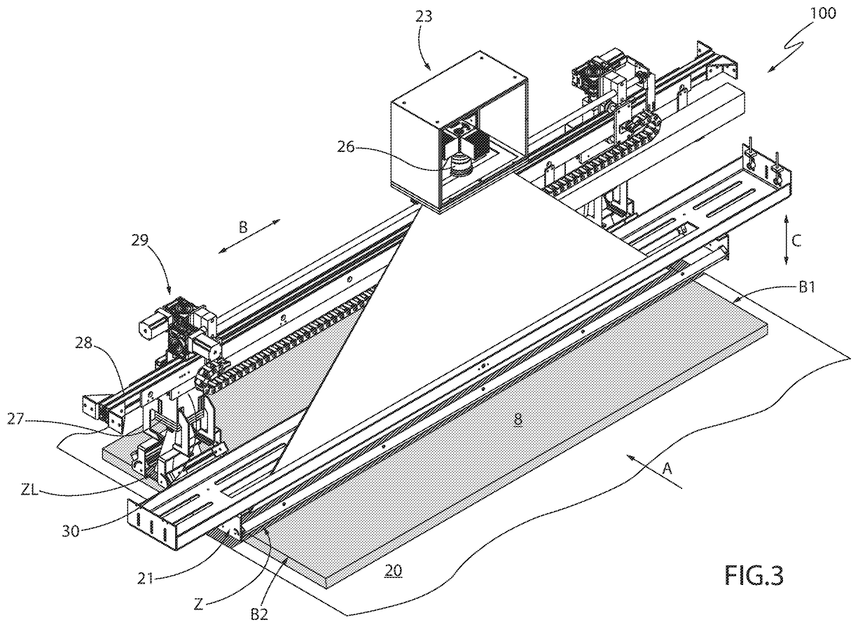

With particular reference to Figures from 3 to 6, advantageously, the control system 100 further comprises a lighting unit 21, which comprises at least one LED bar 22, which extends along a direction B, substantially transverse to the feeding direction A, and is configured to emit at least one light beam towards the feeding surface 20 so as to light at least one zone Z of said feeding surface 20 (see FIG. 3) having an extension, in the direction B, at least equal to the extension of the feeding surface 20. In other words, advantageously, the lighting unit 21 is configured to light at least one entire transverse band of the feeding surface 20.

Advantageously, the control system 100 further comprises an optical detection system 23 for inspecting the substantially flat article 8 at least when the latter is, at least in part, at the zone Z illuminated by the lighting unit 21; in particular, when it is at least in part illuminated by the lighting unit 21.

Such optical detection system 23 is, advantageously, configured to capture at least two images of at least two edge portions of two respective side edges B1 and B2 of the substantially flat article 8 illuminated by the lighting unit 21.

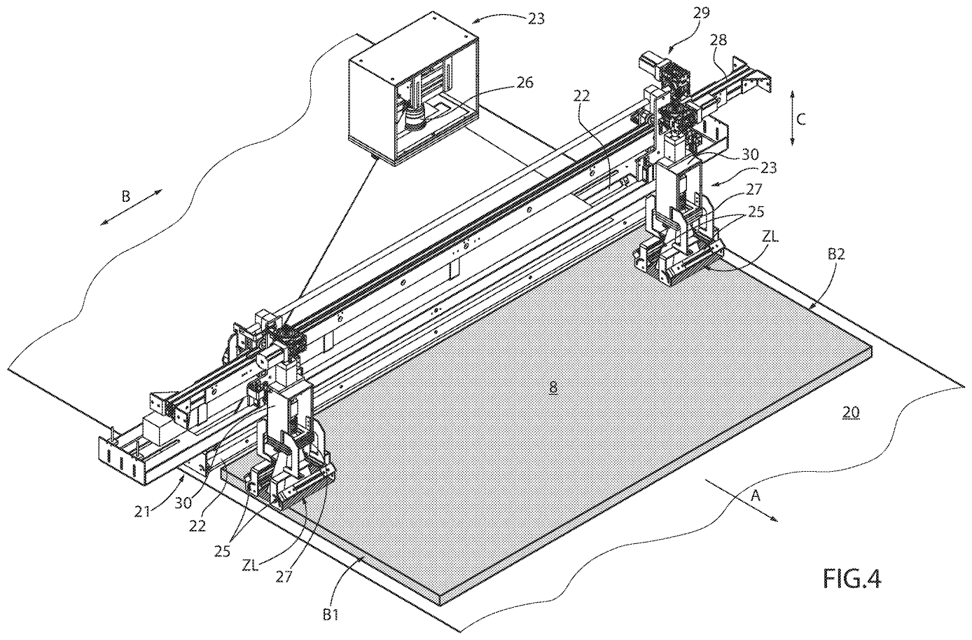

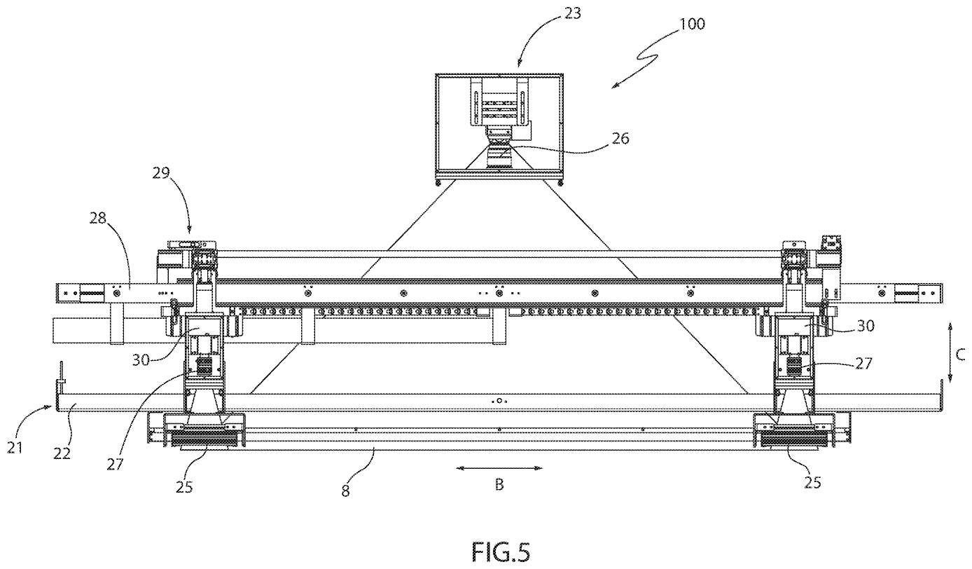

Advantageously but not limitedly, the above-mentioned edge portions comprise (in particular, are), respectively, an area of the article 8 at (in particular, which includes at least part of) a side edge B1 of the article 8 and a further area of the substantially flat article 8 at (in particular, which includes at least part of) a further side edge B2 of the article 8, parallel to and opposite the side edge B2 (see FIGS. 3 and 4).

According to some advantageous but non-limiting embodiments such as, for example, the ones illustrated in the accompanying figures, the optical detection system 23 comprises (in particular, consists of) a pair of side optical capturing devices 27 and each configured to capture one of the above-mentioned at least two further images of the edge portions of the article 8.

Advantageously but not limitedly, such optical detection system 23 is configured to also detect a further image of at least one transverse band of the substantially flat article 8 illuminated by the lighting unit 21.

Specifically, in this case, advantageously but not limitedly, the optical detection system 23 also comprises at least one central optical capturing device 26 arranged between the optical capturing devices 27 and configured to capture the above-mentioned image of the above-mentioned at least one transverse band of the article 8.

Advantageously, the control system 100 also comprises a processing unit 24 configured to process the (in particular, all the) images captured by the optical detection system 23 so as to identify surface defects and/or edge defects present, respectively, in such transverse band and/or in such at least two edge portions of the article 8 (see Figures from 2 to 6).

According to some advantageous but £ non-limiting embodiments, such as for example the ones illustrated in the accompanying Figures from 3 to 6, the lighting unit 21 comprises at least one pair of LED bars 22, consisting of two LED bars 22 parallel to each other, each one of which extends above the feeding surface 20 along the direction B for a section such to cover the entire extension of the feeding surface 20, more in particular, the entire width of the feeding surface 20. Still more advantageously but not limitedly, such LED bars 22 are spaced apart from one another along the feeding direction A and each one of such LED bars 22 comprises a plurality of LEDs oriented towards the opposite LED bar 22 so as to light the above-mentioned zone Z as best as possible.

In particular, according to some advantageous but non-limiting embodiments, the LED bar 22 or, when provided, the pair of LED bars 22, is configured to light a zone Z which comprises both the above-mentioned transverse band of the article 8 and the above-mentioned side portions of the article 8 so that they can be captured by the optical detection system 23.

Still more advantageously but not limitedly, the LED bar 22, or each one of such LED bars 22, comprises a plurality of white LEDs having a luminous power of at least approximately 1100 Lumens; in particular, of at least approximately 1200 Lumens; still more in particular, said luminous power ranges from approximately 1260 to approximately 20000 Lumens.

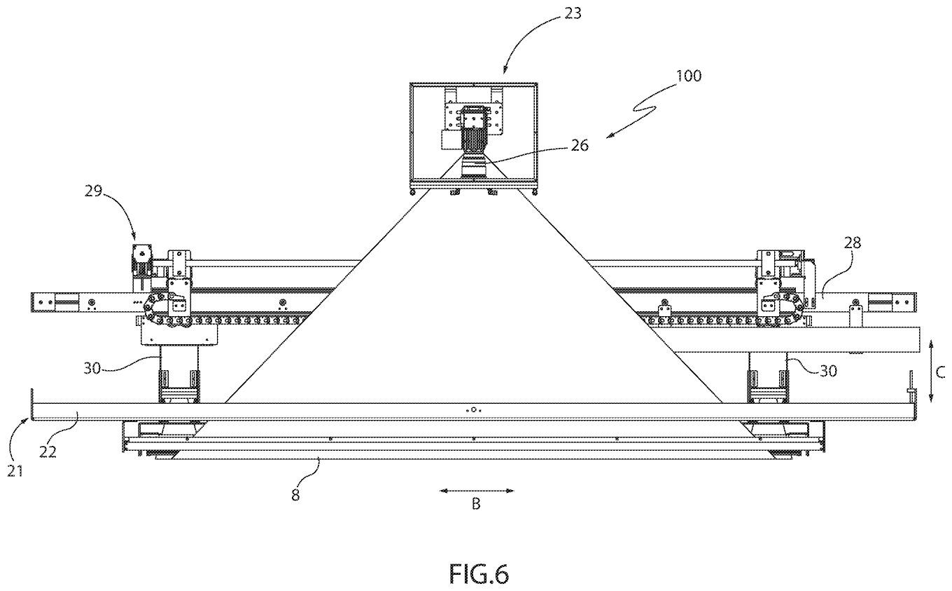

Alternatively or in combination, according to some advantageous but non-limiting embodiments, such as for example the ones illustrated in FIGS. 3, 4 and 6, the lighting unit 21 also comprises at least two further LED bars 25, each one of which extends along the direction B to emit at least one light beam towards the feeding surface 20 so as to light a respective side zone ZL of the feeding surface 20 so as to light the above-mentioned edge portions of the article 8. In other words, advantageously but not limitedly, such further LED bars 25 are arranged in such a way that, in use, the side edges B1, B2 of the substantially flat article 8 are located each at the respective side zones ZL illuminated by such LED bars 25.

More advantageously but not limitedly, the lighting unit 21 comprises a first pair of LED bars 25, which extend along the direction B arranged parallel to and facing each other and spaced apart from each other along the feeding direction A so as to light at least one side zone ZL of the feeding surface 20 which (in use) is located in the proximity of the side edge B1 of the article 8; and a further pair of LED bars 25 which extend along the direction B and are arranged parallel to and facing each other and spaced apart from each other along the feeding direction A to light the other side zone ZL of the feeding surface 20 which (in use) is located in the proximity of the further side edge B2 of the substantially flat article 8.

Advantageously but not limitedly, the side zones ZL have, in the direction B, a smaller extension than the extension, in the direction B, of the zone Z illuminated by the LED bars 22.

Advantageously but not limitedly, also the LED bars 25 each comprise (in particular, consist of) a plurality of white LEDS having a luminous power of at least approximately 1100 Lumens; in particular, of at least approximately 1200 Lumens; still more in particular, said luminous power ranges from approximately 1260 to approximately 20000 Lumens.

Alternatively or in combination, still more advantageously but not limitedly, at least the LED bars 25 (more advantageously, also the LED bars 22) are configured to emit the above-mentioned light beam in an intermittent manner with an emission frequency in phase (namely, balanced) coordination with the capturing frequency of the optical detection system 23. In other words, advantageously but not limitedly, the LED bars 25 comprise (in particular, consist of) LEDS with intermittent light (namely stroboscopic light) with an emission frequency in phase coordination (namely in phase with) the capturing frequency of the detection system 23. This enables further improving the lighting at least of the side zones ZL, improving the ability of the system also to identify even smaller defects. Furthermore, the use of an intermittent light allows, advantageously, lighting the side zones ZL (in particular, also the zone Z) of the feeding surface 20 with high luminous powers, for example in the order of 20000 Lumens, without exceedingly overheating the LED bars 25 (more advantageously, also the LED bars 22) and thus without the need to provide for specially provided cooling devices.

According to some advantageous but non-limiting embodiments, such as for example the ones illustrated in Figures from 3 to 6, the control system 100, in particular the optical detection system 23, comprises at least one guide 28 which extends along the direction B above the feeding surface 20 and carries in a sliding manner each side optical capturing device 27 and the processing unit 24 is configured to determine, based on the above-mentioned image of the transverse band of article 8, at least one first dimension (in particular, the width) of the article 8, in the direction B, and to consequently adjust the mutual position of such side optical capturing devices 27. In particular, each side optical capturing device 27 is connected in a sliding manner to the guide 29 so as to be movable along the guide 28. In this manner it is possible to adjust the mutual distance between the side optical capturing devices 27 depending on the format of the article 8.

In this case, advantageously but not limitedly, the processing unit 24 is configured to determine, based on the above-mentioned image of the transverse band of article 8, at least one first dimension, in the direction B, (in particular, the width) of the article 8 and to cause the side optical capturing devices 27 to move along the guide 28 based on the evaluated dimension so that the distance between the side optical capturing devices 27 is substantially equal to the width of the article 8. In this manner, advantageously, each one of such side optical capturing devices 27, in use, is located at one of the side edges B1, B2 of the article 8 for capturing the images of the edge portions of the substantially flat article 8.

Still more advantageously but not limitedly, the control system 100, in particular the optical detection System 23 further comprises a linear actuation assembly 29 (known per se) which can be actuated by the processing unit 24 for adjusting the mutual distance between such side optical capturing devices 27 (see in particular Figures from 3 to 6). Specifically, according to some advantageous but non-limiting embodiments not illustrated, the linear actuation assembly 29 comprises (in particular, consists of) two independent actuation motors, one for each side optical capturing device 27, and each one can be actuated for moving a respective side optical capturing device 27 in a manner independent of the other one.

Advantageously but not limitedly, in this case, the further LED bars 25, when provided, are integral with the side optical capturing devices 27. Still more advantageously but not limitedly, when the further LED bars 25 mentioned above are provided, such further LED bars 25 and the side optical devices 27 are arranged with respect to one another in such a way that, in use (namely when the control system 100 is actuated for detecting possible surface and/or edge defects of the article 8), each one of the above-mentioned side zones ZL coincides with one of the two edge portions of the two respective side edges B1, B2 of the article 8 illuminated by the lighting unit 21.

More specifically, according to some advantageous but non-limiting embodiments such as, for example, the ones illustrated in Figures from 3 to 6, the control system 100, in particular the optical detection system 23, comprises two trolleys 30 coupled in a sliding manner to the guide 28 and which can be actuated in translation along such guide 28, in particular in the illustrated example by means of the above-mentioned linear actuation assembly 29, and each one configured to carry one of the above-mentioned side optical capturing devices 27 and one of the above-mentioned LED bars 25 or pair of LED bars 25.

Alternatively or in combination, according to some advantageous but non-limiting embodiments, such as for example the ones illustrated, each side optical capturing device 27 and/or each LED bar 25, 22 is further movable along a direction C, perpendicular to the feeding surface 20 (in particular, is movable vertically) so as to allow for the adjustment of the distance between the side optical capturing devices 27 and the feeding surface 20 and/or between the LED bars 25 and the feeding surface 20 depending on the format of the substantially flat article 8 to be controlled.

Advantageously but not limitedly, in this case, the processing unit 24 is configured to move the side optical capturing devices 27 along the direction C depending on the thickness of the article 8 so as to assure that the distance between side optical capturing devices 27 and the article 8 to be detected is equal to maximum approximately 150 mm, in particular ranges from approximately 100 mm to approximately 150 mm and/or to guarantee that the distance between the LED bars 22, 25 and the article 8 to be detected is equal to maximum approximately 28 mm. In this manner, it is possible to assure the correct capturing of the above-mentioned images also of the edge portions of the article 8.

Alternatively or additionally, advantageously but not limitedly, the central optical capturing device 26 is movable along the above-mentioned direction C so as to allow for the adjustment of the distance between such optical capturing device 26 and the feeding surface 20 (in particular, the upper surface of the substantially flat article 8) depending on the format of the substantially flat article 8 to be controlled. Also in this case, more advantageously but not limitedly, the processing unit 24 is configured to move the central optical capturing device 26 along the direction C, depending on the thickness of the article 8, between a first position and a second position, which is distanced from the first position by at least 15 mm; in other words, advantageously but not limitedly, the position of the optical capturing device 26 is adjustable along the direction C so as to assure that the distance between the optical capturing device 26 and the article 8 to be detected is equal to maximum approximately 1500 mm and minimum equal to 500 mm.

Advantageously but not limitedly, each one of the above-mentioned optical capturing devices 26, 27 has a resolution of at least 1 μm; in particular, ranging from approximately 1 μm to approximately 20 μm; still more advantageously, equal to approximately 3.5 μm. Alternatively or additionally, advantageously but not limitedly, each one of the above-mentioned optical capturing devices 26, 27 has a field depth ranging from approximately 0.5 mm to approximately 8 mm; still more in particular, ranging from approximately 1 mm to approximately 5 mm.

More advantageously but not limitedly, each one of the above-mentioned optical capturing devices 26 and 27 comprises (in particular, consists of) a camera.

Still more specifically, advantageously but not limitedly, each one of the optical capturing devices 26 and 27 comprises (in particular, consists of) a matrix camera having a resolution ranging from approximately 5 MP; in particular from approximately 12 MP, to approximately 50 MP.

According to some advantageous but non-limiting embodiments, the optical capturing device 27 comprises (in particular, consists of) at least two cameras of the type described above.

According to some advantageous non-limiting embodiments, the processing unit 24 comprises a memory (not visible in the accompanying figures) for storing a library containing a plurality of known defects, in particular known surface and/or edge defects, and a processor (of known type), which advantageously but not limitedly coincides with the processing unit 24, configured to process the images detected by the optical detection system 23 and to identify possible shadings present in such images and compare such possible shadings with the data stored in the memory in order to check whether the article 8 suffers from one or more of the defects stored in such library.

More specifically, according to some advantageous but non-limiting embodiments, the processing unit 24 is configured to process the images detected by the optical detection system 23 by means of pattern matching techniques.

In particular, according to some advantageous but non-limiting embodiments, the processing unit 24 is configured to analyse such images captured by the optical detection system 23 by means of pattern matching algorithms of known type.

According to some advantageous but non-limiting embodiments, such pattern matching algorithms are based on the Hough transform, which enables identifying segments on the images so that the processing unit 24 by comparing such segments with the known defects stored in the above-mentioned memory can identify possible surface and/or edge defects.

Alternatively or additionally, advantageously but not limitedly, the processing unit 24 is configured to: extract, by means of pattern matching techniques known per se, from the images detected by the optical detection system 23, sub-images comprising the areas in which shadings are present which could correspond to a potential defect and to analyse such sub-images, by means of analysis algorithms, the so-called skeleton algorithms, for reconstructing the edge of such possible defects, for example by labelling each pixel of the image based on the distance between each pixel and its closest neighbour and/or the intensity, so as to be able to combine them for defining a representation or skeleton of the potential defect; and to assign a score to each one of such sub-images. The higher the score, i.e. the more the skeleton algorithm has maintained the potential defect unaltered, the greater the probability that it actually is a defect, for example a crack. In this case, therefore, advantageously but not limitedly, the processing unit 24 is configured to identify the potential defects also based on what deduced by means of said skeleton algorithm; more in particular, based on the value of such score.

In particular, advantageously but not limitedly, the processing unit 24 is configured to process/analyse the images captured by means of the side optical capturing devices 27 in order to identify possible edge defects, such as for example cracks or fissures; whereas, the image captured by the central optical capturing device 26 in order to identify possible surface defects, such as inclusions of air bubbles.

According to some advantageous but non-limiting embodiments of the present invention, the processing unit 24 is also configured to determine the format, more in particular at least the width and the thickness of the substantially flat article 8 by analysing the image of the above-mentioned transverse band of the article 8 captured by the central optical capturing device 26 so as to consequently adjust the position of the side optical capturing devices 27 and/or of the LED bars 22, 25 both along the direction B and along the direction C and, when provided, to also adjust the position of the optical capturing device 26 along the direction C as explained above.

Alternatively or in combination, according to some advantageous but non-limiting embodiments, the control system 100 comprises a user interface 31 through which an operator can input setting data, among which, for example, the format of the substantially flat articles 8 made of a ceramic material to be controlled. For example, in the embodiment illustrated in FIG. 2, such user interface 31 comprises (in particular, consists of) a screen and a keyboard.

Still according to other embodiments, the control system 100, in particular, the processing unit 24, is in communication with the other components of the manufacturing plant 1 for manufacturing ceramic products 2 in which the control system 100 is installed for receiving data, at least approximately the format of the substantially flat article 8, from other components of said manufacturing plant 1 for manufacturing ceramic products 2. Specifically, according to some advantageous but non-limiting embodiments, the processing unit 24 is in communication with the forming assembly 6 for receiving such data concerning the format of the article 8.

Furthermore, according to some advantageous but non-limiting embodiments, in this case (namely, when the control system 100—more in particular the celebration unit 24—is in communication with the other components of the manufacturing plant 1), the data processed by the processing unit 24 concerning the integrity of the articles 8 can be utilized also for adjusting, in feedback, the operation of the supply assembly 3 and/or of the forming assembly 6, for example by modifying one or more operating parameters, depending on the type of detected surface and/or edge defects. Specifically, advantageously but not limitedly, the data processed by the processing unit 24 concerning the integrity of the articles 8 can be used for varying the density of the substantially flat article 2, for example, by locally increasing the quantity of ceramic powder CP supplied by the supply assembly 3, suitably adjusting the position and the operation of the supply device 4, or by adjusting the operation of the compaction device 12.

According to some advantageous but non-limiting embodiments non illustrated, the control system 100 also comprises at least one detector, for example an encoder arranged along the feeding path P, configured to detect the presence and/or the position of the substantially flat article 8 on the feeding surface 20 (in particular, in the action zone of the optical detection system 23), and the processing unit 24 is configured to control the actuation of the optical detection system 23 and/or of the lighting unit 21 depending on the data detected by such detector. Still more advantageously but not limitedly, the control system 100 comprises two detectors, for example two encoders connected to the conveyor assembly 9 (namely fixed to the conveyor 18), arranged in sequence along the feeding path P and spaced apart from one another by a distance such that a detector (the one more upstream along the feeding path P) detects the presence and/or the position of the substantially flat article 8 at the input on the feeding surface 20 (in particular, in the action zone of the optical detection system 23) and the other detector, arranged downstream of the first one along the given path P, detects the presence and/or the position of the substantially flat article 8 at the optical detection system 23. More specifically, advantageously but not limitedly, the distance between the two detectors along the feeding path P is variable between approximately 200 mm and approximately 600 mm. This allows improving the degree of precision with which the feeding of the substantially flat article 8 along the feeding path P is detected. In this case, the processing unit 24 is configured to control the actuation of the optical detection system 23 and/or of the lighting unit 21 based on the detection data of both detectors.

With particular reference to FIG. 2, according to some advantageous but non-limiting embodiments, the control system 100 comprises a support structure 32 configured to carry at least the lighting unit 21 and the optical detection system 23. More specifically, advantageously but not limitedly, such support structure 32 comprises (in particular, consists of) a portal configured to surmount the belt conveying device 18 which defines the above-mentioned feeding surface 20. Still more advantageously, but not limitedly, the support structure 32 has a beam 33 dimensioned for containing and protecting from the outside the lighting unit 21 and the optical detection system 23, and two pillars 34 which hold such beam 33 and carry at least the processing unit 24.

Advantageously but not limitedly, the beam 33 is open at the bottom on the side of the feeding surface 20 for allowing the lighting unit 21 to light the substantially flat articles 8 which move on the feeding surface 20, as explained above, and the optical detection system 23 to capture images of such articles 8, as explained above.

The presence of such support structure 32 allows protecting, in a simple and cost-effective manner, the more delicate and expensive components of the control system 100, such as the lighting unit 21 and the optical detection system 23, from dust and/or possible other materials which could damage them.

According to some advantageous but non-limiting embodiments not illustrated, the control system 100 also comprises a warning unit, for example a pilot light or a sound emitter, which can be actuated for emitting an alert signal when a surface and/or edge defect is detected. Alternatively, the alert signal can, for example, be displayed by means of the above-mentioned user interface 31 or can be transmitted by the processing unit 24 to a control station of the manufacturing plant 1 in which the control system 100 is installed, possibly placed in a remote station.

According to another aspect of the present invention, a control method is proposed for controlling the integrity of articles 8 made of a compacted ceramic material, such as the ones described above. Advantageously but not limitedly, such control method is actuated by means of the control system 100 described above.

The control method comprises the following steps: a supplying step, during which at least one substantially flat article 8 comprising (in particular, made of) a compacted ceramic material is fed on a feeding surface 20 (advantageously but not limitedly of the type described above) along a feeding path P in a feeding direction A; a lighting step, during which a lighting unit 21 (advantageously but not limitedly of the type described above), comprising at least one LED bar 22 which extends along a direction B, substantially transverse to the feeding direction A, emits at least one light beam towards the feeding surface 20 and lights at least one zone Z of the feeding surface 20 having an extension, in the direction B, at least equal to the extension of the feeding surface 20; and a detecting step, (at least partially) simultaneous with the lighting step, during which an optical detection system 23 which comprises a pair of optical capturing devices 27 captures at least two images of two edge portions of the substantially flat article 8 illuminated by the lighting unit 21. In particular, as better explained with regard to the control system 100, during such detecting step each one of the optical capturing devices 27 of the above-mentioned pair captures the image of a respective edge portion of the substantially flat article 8.

As already explained in detail with regard to the control system 100 (and not repeated herein for the sake of brevity), according to some advantageous but non-limiting embodiments, the lighting unit 21 comprises a pair of LED bars 22, and during such lighting step both LED bars 22 emit a light beam for lighting the zone Z, which advantageously but not limitedly is of the type described above. Alternatively or in combination, the lighting unit 21 also comprises at least two further LED bars 25, more in particular, a pair of LED bars 25), and during the above-mentioned lighting step each one of the LED bars 25 emits a light beam towards the feeding surface 20 so as to light the side zones ZL of the article 8, which extend in the proximity of (in particular, comprise) the side edges B1 and B2 of the article 8 as already described in detail with regard to the control system 100.

The control method further comprises an image processing step, (at least partially) subsequent to the lighting step, during which the images captured during the detecting step are processed by a processing unit 24 so as to identify defects present in the two edge portions of two respective side edges B1, B2 of the article 8.

According to some advantageous but non-limiting embodiments, during the detecting step of the control method the optical detection system 23 captures at least one further image of a transverse band of the substantially flat article 8 illuminated by the lighting unit 21 and during the image processing step, also such further image captured during the detecting step is processed by the processing unit 24 so as to identify possible defects (in particular, surface defects) present in such transverse band of said substantially flat article (8).

According to some advantageous but non-limiting embodiments, the control method also comprises a warning step, (at least partially) subsequent to the processing step, during which a warning unit (not visible in the accompanying figures) emits an alert signal when a surface and/or edge defect is detected, for example by means of a pilot light, an acoustic signal or a message that can be displayed by means of a user interface 31 (for example part of the control system 100 with which the method is actuated), or can be automatically sent to a control station, in a remote station.

Advantageously but not limitedly, the lighting step and the detecting step are (at least partially) simultaneous with the supplying step.

According to some advantageous but non-limiting embodiments, the detecting step comprises: a first detecting sub-step, during which a pair of side optical capturing devices 27, part of the optical detection system 23 (advantageously but not limitedly, being as described above with regard to the control system 100), captures the above-mentioned images of the edge portions of the article 8; and a further detecting sub-step, (at least partially) subsequent to the already mentioned detecting sub-step, during which a central optical capturing device 26, which (advantageously but not limitedly, is as described above with regard to the control system 100 and) is part of the optical detection system 23, captures the above-mentioned image of the transverse band of the article 8.

In particular, advantageously but not limitedly, during the above-mentioned detecting sub-step each one of the side optical devices 27 captures one of the above-mentioned two further images of the edge portions of the substantially flat article 8 made of a compacted ceramic material.

According to some advantageous but non-limiting embodiments, the control method also comprises: an identifying step, (at least partially) subsequent to the detecting step, during which the processing unit 24, based on the further image of the transverse band of article 8 captured during the detecting step determines at least one first dimension, in the direction B, of the article 8 (in particular, determines at least the width of the article 8); and an adjusting step, during which the position of each one of the side optical capturing devices 27 is adjusted based on the data determined in such identifying step so that each one of such side optical capturing devices 27 is located at one of the side edges B1 or B2 of the substantially flat article 8 so as to be able to capture the above-mentioned further images of the above-mentioned edge portions of the substantially flat article 8. Alternatively or additionally, during the adjusting step, the position of the LED bars 25 is adjusted based on the data determined in such identifying step for lighting in a suitable manner the edge portion zones 4 the substantially flat article 8.

Specifically, advantageously but not limitedly, in this case, the adjusting step comprises a transverse adjusting sub-step, during which the side optical capturing devices 27 and/or the LED bars 25 are moved in the direction B (advantageously but not limitedly are caused to move along a guide 28 which extends above the feeding surface 20, as is better described with regard to the control system 100) so that the distance between such side optical capturing devices 27 along the direction B is substantially equal to the dimension of the article 8 in such direction B (namely is equal to the width of the article 8). Alternatively or in combination, the adjusting step provides for a vertical adjusting sub-step, during which the side optical capturing devices 27 and/or the LED bars 25 are moved in a direction C, perpendicular to the feeding surface 20, for adjusting the distance between the side optical capturing devices 27 and the substantially flat article 8 which, in use, is fed on the feeding surface 20, depending on the format of the article 8; in particular, at least depending on the thickness of the article 8.

Alternatively or additionally, advantageously but not limitedly, the method also provides for an adjusting step of the position of the central optical capturing device 26, during which also the position of the central optical capturing device 26 is adjusted at least along the direction C based on the format of the article 8.

As already specifically explained with regard to the control system 100, according to some embodiments, the format of the article 8 is determined during the above-mentioned processing step. According to other advantageous but non-limiting embodiments, the control method also provides for an initial setting step, during which the data relative to the format of the articles 8 to be controlled are input for example by means of a user interface 31.

Still according to a last aspect of the present invention, a manufacturing method for manufacturing ceramic products 2, such as ceramic slabs or tiles, is presented which advantageously but not limitedly is actuated by means of the manufacturing plant 1 described above.

Specifically, advantageously, the manufacturing method comprises: a supplying step, during which a supplying assembly 6 supplies some (in particular, a given/controlled quantity of) ceramic powder CP at an input station 5; a forming step, during which a forming assembly 6 arranged at a forming station 7 (and advantageously but not limitedly being as described above with regard to the manufacturing plant 1) applies at least one compaction pressure to the ceramic powder CP and forms at least one substantially flat article 8 comprising (in particular, made of) a compacted ceramic material; and a firing step, during which such substantially flat articles 8 made of a compacted ceramic material are fired in a kiln 11 for obtaining the ceramic products 2. According to some advantageous but non-limiting embodiments, the method also comprises a drying step, during which the articles 8 are dried in a drier 17 and/or possible further finishing decorating steps.

Advantageously the manufacturing method also comprises a conveying step, during which a conveyor assembly 9 (advantageously but not limitedly, of the type described above with regard to the manufacturing apparatus 1) transports along a given path PA in a feeding direction A the ceramic powder CP from the input station 5 to said forming station 7 and transports the above-mentioned substantially flat article 8 from the forming station 7 to the kiln 11.

The manufacturing method for manufacturing ceramic products 2 further comprises an integrity control step for controlling the integrity of the substantially flat article 8, which is (at least partially) prior to the firing step, and when provided, also to the drying step, so that the integrity of the articles 8 is controlled before the heat treatment operations of the articles 8. Advantageously, such control step is actuated in accordance with the control method described above.

Advantageously but not limitedly, such integrity control step is (at least partially) subsequent to the forming step.

According to some advantageous but non-limiting embodiments, the manufacturing method for manufacturing ceramic products 2 also comprises a feedback control step, (at least partially) subsequent to the processing step, during which the supplying step and the forming step are adjusted in feedback based on the type of surface and/or edge defects detected during the integrity control step, for example by modifying one or more operating parameters of the devices intended for carrying out said steps. In detail, as explained above with regard to the control system 100, according to some advantageous but non-limiting embodiments, during such feedback control step the quantity of ceramic powder CP supplied by the supply assembly 3 is locally varied and/or the actuation of the forming assembly 6 is adjusted, for example for varying the density of the substantially flat article 2.

The present invention has numerous advantages, among which the following are mentioned.

The control method and system of the present invention allow controlling in a more precise and systematic manner the integrity of the substantially flat articles 8 made of a compacted ceramic material, eliminating, or anyway sensibly reducing, the risk that articles 8 with imperfections, in particular suffering from surface and/or edge defects, reach the heat treatment systems, such as for example the drier 17 and the kiln 11. In this manner, the risk of damage of such heat treatment systems 11, 17 is avoided, and the need for long and complex maintenance or restoring operations is eliminated, thereby increasing the efficiency and the productivity of the method and of the manufacturing apparatus 1 for manufacturing ceramic products 2.

Furthermore, with respect to the known control methods and systems, the control method and system 100 of the present invention allow identifying possible surface or edge defects with high precision without the need to utilize contrast media, thus reducing the number of operations to be accomplished and therefore the costs, the result being equal.

A further advantage is that the control method and system 100 of the present invention perfectly and easily adapt to the methods and to the manufacturing plants 1 for manufacturing ceramic products 2, improving the efficiency thereof and reducing the need for labour.

1. A control system to control the integrity of articles made of a compacted ceramic material; said control system comprises:
a feeding surface to receive at least one substantially flat article comprising a compacted ceramic material and convey it along a feeding path in a feeding direction;
a lighting unit, which comprises at least one LED bar, which extends along a direction, substantially transverse to said feeding direction, and is configured to emit at least one light beam towards said feeding surface so as to light at least one zone of said feeding surface having an extension, in the direction, at least equal to the extension of said feeding surface;
an optical detection system to inspect said substantially flat article; said optical detection system is configured to capture at least two images of at least two edge portions of two respective side edges of said substantially flat article illuminated by said lighting unit and comprises a pair of optical capturing devices, each one configured to capture one of said at least two images of said edge portions of said substantially flat article; and
a processing unit configured to process said images captured by said optical detection system so as to identify possible defects present in said at least two edge portions of said substantially flat article.

2. The control system according to claim 1, wherein: said optical detection system is configured to capture at least one further image of at least one transverse band of said substantially flat article illuminated by said lighting unit; and said processing unit is configured to also process said further image of at least one transverse band of said substantially flat article so as to identify possible defects present in said at least one transverse band of said substantially flat article.

3. The control system according to claim 2, wherein said optical detection system comprises a further optical capturing device, which is arranged between said optical capturing devices of said pair of optical capturing devices and is configured to capture said at least one further image of said at least one transverse band of said substantially flat article.

4. The control system according to claim 1, wherein: said lighting unit comprises at least two further LED bars, each extending along said direction so as to emit at least one light beam towards said feeding surface in order to light a respective side zone of said feeding surface; and
said further LED bars being arranged in such a way that, in use, said side edges of said substantially flat article are located each at a respective side zone.

5. The control system according to claim 1, wherein: said optical detection system comprises a guide, which extends along said direction above said feeding surface; and each one of the optical capturing devices of said pair of optical capturing devices is connected to said guide in a sliding manner; and
said processing unit is configured to determine at least one first dimension of said substantially flat article in said direction and, based on said first dimension, to cause said optical capturing devices to move along said guide so that the distance between said optical capturing devices of said pair of optical capturing devices is substantially equal to said dimension of said substantially flat article;
in particular, said further LED bars are integral with said optical side devices.

6. The control system according to claim 5, wherein each one of said optical capturing devices of said pair of optical capturing devices is movable along a direction perpendicular to said feeding surface so as to allow for the adjustment of the distance between said optical capturing devices and said feeding surface depending on the format of the substantially flat article;
in particular, also said further optical capturing device is movable along said direction so as to vary the distance with respect to said feeding surface depending on the format of the substantially flat article.

7. The control system according to claim 1, wherein said processing unit comprises a memory to store a library containing a plurality of known defects and a processor configured to process said images detected by said optical detection system and compare them with the contents of said memory in order to check whether the substantially flat article suffers from one or more of said defects of said plurality of known defects.

8. The control system according to claim 1, wherein said at least one LED bar of said lighting unit comprises a plurality of white LEDs having a luminous power of at least approximately 1100 Lumens.

9. The control system according to claim 1, wherein said at least one LED bar of said lighting unit is configured to emit said light beam in an intermittent manner.

10. The control system according to claim 1, wherein each one of said optical devices has a resolution of at least 1 μm.

11. A manufacturing plant to manufacture ceramic products, such as ceramic slabs and tiles; said manufacturing plant comprises:
a supply assembly, which is configured to supply ceramic powder at an input station;
a forming assembly arranged at a forming station and configured to form at least one substantially flat article comprising a compacted ceramic material, said forming assembly comprising at least one compaction device configured to apply a compaction pressure to said ceramic powder;
a kiln configured to fire said at least one substantially flat ceramic article made of a compacted ceramic material and obtain a ceramic product;
a conveyor assembly to transport, along a given path in a feeding direction, said ceramic powder from said input station to said forming station and said substantially flat article from said forming station to said kiln; and
a control system to control the integrity of substantially flat articles made of a compacted ceramic material, said control system being arranged upstream of said kiln along said given path and being according to claim 1.

12. A control method to control the integrity of articles made of a compacted ceramic material; said control method comprises the following steps:
a supplying step, during which at least one substantially flat article comprising a compacted ceramic material is fed on a feeding surface along a feeding path in a feeding direction;
a lighting step, during which a lighting unit, which comprises at least one LED bar extending along a direction, substantially transverse to said feeding direction, emits at least one light beam towards said feeding surface and lights at least one zone of said feeding surface having an extension, in said direction, at least equal to the extension of said feeding surface;
a detecting step, which is at least partially simultaneous with said lighting step and during which an optical detection system comprising a pair of optical capturing devices, captures at least two images of two edge portions of said substantially flat article illuminated by said lighting unit; and
an image processing step, which is at least partially subsequent to said lighting step and during which the images captured during said detecting step are processed by a processing unit so as to identify possible defects present in said at least two edge portions of two respective side edges of said substantially flat article.

13. The control method according to claim 12, wherein, during said detecting step, said optical detection system captures at least one further image of a transverse band of said substantially flat article illuminated by said lighting unit and, during said image processing step, said further image captured during said detecting step is also processed by said processing unit so as to identify possible defects present in said transverse band of said substantially flat article.

14. The control method according to claim 13, wherein said detecting step comprises: a first detecting sub-step, during which said pair of optical capturing devices captures said images of said edge portions of said substantially flat article; and a second detecting sub-step, which is at least partially subsequent to said first detecting sub-step and during which a further optical capturing device, which is part of said optical detection system captures said further image of said at least one transverse band of said substantially flat article.

15. The control method according to claim 14 and comprising: a first identifying step, which is at least partially subsequent to said detecting step and during which said processing unit, based on said at least one further image, determines at least one first dimension of said substantially flat article in said direction; and an adjusting step, during which the position of each one of said optical capturing devices of said pair of optical capturing devices is adjusted based on the data determined in said identifying step, so that each one of said optical capturing devices is located at one of said side edges of said substantially flat article so as to be able to capture said images of said at least edge portions.

16. The control method according to claim 15, wherein said adjusting step comprises a transverse adjusting sub-step, during which said optical capturing devices are moved in said direction so that the distance between them is substantially equal to said dimension of said substantially flat article and/or a vertical adjusting sub-step, during which said optical capturing devices are moved in a direction, which is perpendicular to said feeding surface, so as to adjust the distance between said optical capturing devices and said substantially flat article depending on the format of said substantially flat article;
in particular, during said vertical adjusting sub-step the position of said further optical capturing device along said direction is also adjusted.

17. The control method according to claim 12 and comprising a warning step, which is at least partially subsequent to said processing step and during which a warning unit emits an alert signal when a defect is detected.

18. A manufacturing method to manufacture ceramic products, such as ceramic slabs and tiles; said manufacturing method comprises:
a supplying step, during which a supply assembly supplies ceramic powder at an input station;
a forming step, during which a forming assembly arranged at a forming station applies at least a compaction pressure to said ceramic powder and forms at least one substantially flat article comprising a compacted ceramic material;
a firing step, during which said at least one substantially flat article made of a compacted ceramic material is fired in a kiln;
a conveying step, during which a conveyor assembly transports, along a given path in a feeding direction, said ceramic powder from said input station to said forming station and said substantially flat article from said forming station to said kiln; and
an integrity control step, which is at least partially prior to the firing step, to control the integrity of said substantially flat article comprising a compacted ceramic material before said firing step; said control step being actuated according to the control method claimed in claim 12.
